(19) United States
(12) Patent Application Publication
(10) Pub. No.: US 2024/0386394 A1
(43) Pub. Date: Nov. 21, 2024

(54) NON-TRANSITORY COMPUTER READABLE MEDIUM

(71) Applicant: TOYOTA JIDOSHA KABUSHIKI KAISHA, Toyota-shi (JP)

(72) Inventors: Yu NAGATA, Chofu-shi (JP); Shun HASHIMOTO, Kiyosu-shi (JP); Kota YAMAZAKI, Kasugai-shi (JP); Akane MASAKI, Nisshin-shi (JP); Wataru ETO, Nagoya-shi (JP); Makoto AKAHANE, Yokohama-shi (JP)

(73) Assignee: TOYOTA JIDOSHA KABUSHIKI KAISHA, Toyota-shi (JP)

(21) Appl. No.: 18/664,915

(22) Filed: May 15, 2024

(30) Foreign Application Priority Data
May 17, 2023 (JP) 2023-081833

(51) Int. Cl. G06Q 10/20; B60L 53/00; B60L 58/10; G01C 21/36

(52) U.S. Cl. CPC G06Q 10/20; B60L 53/00; B60L 58/10; G01C 21/3679

(57) ABSTRACT

A terminal program for requesting a service to dispatch a service staff or a service vehicle to a location in which a user vehicle is parked and charge a battery installed in the user vehicle causes a computer to execute operations, the operations including presenting method data indicating a charging method that can be used by a user for each service staff or service vehicle to the user and accepting a user operation to select a service staff or a service vehicle, and transmitting request data indicating the service staff or the service vehicle selected by the user operation and requesting the service to a server apparatus.

### CROSS-REFERENCE TO RELATED APPLICATION

This application claims priority to Japanese Patent Application No. 2023-081833 filed on May 17, 2023, the entire contents of which are incorporated herein by reference.

### TECHNICAL FIELD

The present disclosure relates to a terminal program.

### BACKGROUND

Patent Literature (PTL) 1 discloses a system to provide a service to charge vehicles on behalf of users and a service to dispatch power supply vehicles.

### CITATION LIST

### Patent Literature

PTL 1: JP 2020-107303 A
PTL 2: US 2020/0001727 A1
PTL 3: CN 106157625 A

### SUMMARY

In a service to charge vehicles on behalf of users, it is desirable for the users to be able to select agents that are suitable for their needs. In a service to dispatch power supply vehicles, it is also desirable for the users to be able to select power supply vehicles that are suitable for their needs.

It would be helpful for users to be able to select agents or power supply vehicles that are suitable for their needs when receiving a service to charge vehicles on behalf of the users or a service to dispatch power supply vehicles.

A terminal program according to the present disclosure is a terminal program for requesting a service to dispatch a service staff or a service vehicle to a location in which a user vehicle is parked and charge a battery installed in the user vehicle, the terminal program being configured to cause a computer to execute operations, the operations including:
presenting method data indicating a charging method that can be used by a user for each service staff or service vehicle to the user and accepting a user operation to select a service staff or a service vehicle; and
transmitting request data indicating the service staff or the service vehicle selected by the user operation and requesting the service to a server apparatus.

According to the present disclosure, users can select agents or power supply vehicles that are suitable for their needs when receiving a service to charge vehicles on behalf of the users or a service to dispatch power supply vehicles.

### BRIEF DESCRIPTION OF THE DRAWINGS

In the accompanying drawings:

FIG. 1 is a diagram illustrating a configuration of a service provision system according to an embodiment of the present disclosure;

FIG. 2 is a block diagram illustrating a configuration of a server apparatus according to the embodiment of the present disclosure;

FIG. 3 is a block diagram illustrating a configuration of a terminal apparatus according to the embodiment of the present disclosure; and

FIG. 4 is a flowchart illustrating operations of the service provision system according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

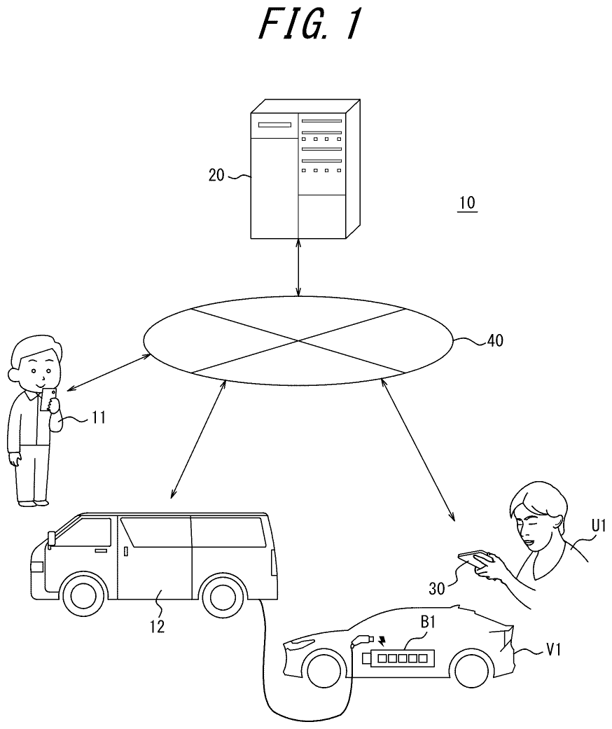

A configuration of a service provision system 10 according to the present embodiment will be described with reference to FIG. 1.

The service provision system 10 includes a server apparatus 20 and a terminal apparatus 30. The server apparatus 20 can communicate with the terminal apparatus 30 via a network 40. The server apparatus 20 may be able to communicate via the network 40 with a mobile device such as a mobile phone, smartphone, or tablet held by a service staff 11. The server apparatus 20 may be able to communicate via the network 40 with an in-vehicle device installed in a service vehicle 12 or a mobile device such as a mobile phone, smartphone, or tablet held by a staff on board the service vehicle 12. The terminal apparatus 30 may also be able to communicate via the network 40 with the mobile device held by the service staff 11, the in-vehicle device installed in the service vehicle 12, or the mobile device held by the staff on board the service vehicle 12.

The server apparatus 20 is a computer that belongs to a cloud computing system or other computing system installed in a facility such as a data center. The server apparatus 20 is operated by a charging service provider.

The terminal apparatus 30 is, for example, a mobile device such as a mobile phone, smartphone, or tablet held by each user. The terminal apparatus 30 executes a terminal program to request a charging service.

The charging service is a service to dispatch the service staff 11 or the service vehicle 12 to a location in which a user vehicle is parked and charge a battery installed in the user vehicle. In the present embodiment, the user vehicle is a BEV or a PHEV. The term “BEV” is an abbreviation of battery electric vehicle. The term “PHEV” is an abbreviation of plug-in hybrid electric vehicle. The user vehicle may be a MaaS-dedicated vehicle. The term “MaaS” is an abbreviation of Mobility as a Service.

The charging service includes at least an agent-type service or a mobile-type service, and includes both of the agent-type service and the mobile-type service in the present embodiment. The agent-type service is a service to dispatch the service staff 11 to the location in which the user vehicle is parked, have the dispatched service staff 11 move the user vehicle to another location, and charge the battery installed in the user vehicle in the location to which the user vehicle is moved. The mobile-type service is a service to dispatch the service vehicle 12 to the location in which the user vehicle is parked and have the dispatched service vehicle 12 charge the battery installed in the user vehicle in the location in which the user vehicle is parked.

In the present embodiment, either the agent-type service or the mobile-type service is selected by each user or automatically, and provided as the charging service. In other words, in the present embodiment, the agent-type charging service or the mobile-type charging service is selectively provided. For example, in the agent-type charging service, while a user U1 is not using a user vehicle V1, a worker as the service staff 11 drives the user vehicle V1 from a parking lot to a charging station, charges a battery BI of the user vehicle V1, and then returns the user vehicle V1. In the mobile-type charging service, a mobile charging vehicle as the service vehicle 12 comes to the parking lot, and charges the battery BI of the user vehicle V1 on the spot.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The terminal apparatus 30 presents method data to a user and accepts a user operation to select a service staff 11 or a service vehicle 12. The method data is data indicating a charging method that can be used by the user for each service staff 11 or service vehicle 12. The terminal apparatus 30 transmits request data to the server apparatus 20. The request data is data requesting the charging service with indication of the service staff 11 or the service vehicle 12 that is selected by the user operation. Upon receiving the request data from the terminal apparatus 30, the server apparatus 20 performs a process of dispatching the service staff 11 or the service vehicle 12 indicated by the request data.

According to the present embodiment, the user can select a service staff 11 or a service vehicle 12 that is suitable for their needs when receiving the charging service. For example, when receiving the agent-type charging service, the user U1 can select an appropriate worker, since the user U1 can know of what charging method can be supported in the charging station to which each worker is to move the user vehicle V1. When receiving the mobile-type charging service, the user U1 can select an appropriate mobile charging vehicle since the user U1 can know of what charging method each mobile charging vehicle can support.

In the present embodiment, the request data is data indicating the parking location together with the service staff 11 or the service vehicle 12 that is selected by the user operation and requesting the charging service. In response to the request data, the server apparatus 20 transmits data indicating the parking location to the mobile device held by the service staff 11 indicated by the request data, the in-vehicle device installed in the service vehicle 12 indicated by the request data, or the mobile device held by the staff on board the service vehicle 12 indicated by the request data. In other words, the terminal apparatus 30 notifies the service staff 11 selected by the user operation, the service vehicle 12 selected by the user operation, or the staff on board the service vehicle 12 selected by the user operation of the parking location via the server apparatus 20.

The service staff 11 selected by the user operation, the service vehicle 12 selected by the user operation, or the staff on board the service vehicle 12 selected by the user operation may be notified of the parking location directly, rather than via the server apparatus 20. In such a variation, the terminal apparatus 30 transmits to the server apparatus 20, as the request data, data indicating only the service staff 11 or the service vehicle 12 that is selected by the user operation, without indicating the parking location, and requesting the charging service. The terminal apparatus 30 transmits the data indicating the parking location to the mobile device held by the service staff 11 selected by the user operation, the in-vehicle device installed in the service vehicle 12 selected by the user operation, or the mobile device held by the staff on board the service vehicle 12 selected by the user operation. Upon receiving the request data from the terminal apparatus 30, the server apparatus 20 performs the process of dispatching the service staff 11 or the service vehicle 12 indicated by the request data, while working with the mobile device held by the service staff 11 indicated by the request data, the in-vehicle device installed in the service vehicle 12 indicated by the request data, or the mobile device held by the staff on board the service vehicle 12 indicated by the request data.

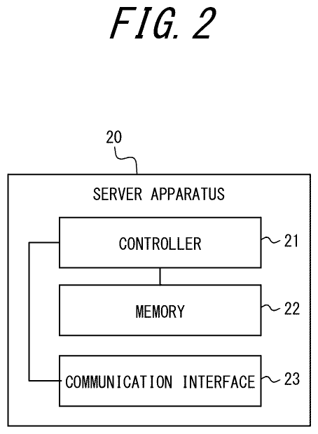

A configuration of the server apparatus 20 according to the present embodiment will be described with reference to FIG. 2.

The server apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the server apparatus 20 while controlling components of the server apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores data to be used for operations of the server apparatus 20 and data obtained by the operations of the server apparatus 20.

The communication interface 23 includes at least one communication module. The communication module is, for example, a module compatible with a wired LAN communication standard such as Ethernet® (Ethernet is a registered trademark in Japan, other countries, or both) or a wireless LAN communication standard such as IEEE802.11. The name “IEEE” is an abbreviation of Institute of Electrical and Electronics Engineers. The communication interface 23 communicates with the terminal apparatus 30. The communication interface 23 may communicate with the mobile device held by the service staff 11. The communication interface 23 may communicate with the in-vehicle device installed in the service vehicle 12 or the mobile device held by the staff on board the service vehicle 12. The communication interface 23 receives data to be used for the operations of the server apparatus 20, and transmits data obtained by the operations of the server apparatus 20.

The functions of the server apparatus 20 are realized by execution of a server program according to the present embodiment by a processor serving as the controller 21. That is, the functions of the server apparatus 20 are realized by software. The server program causes a computer to execute the operations of the server apparatus 20, thereby causing the computer to function as the server apparatus 20. That is, the computer executes the operations of the server apparatus 20 in accordance with the server program to thereby function as the server apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the server apparatus 20 may be realized by a programmable circuit or a dedicated circuit serving as the controller 21. That is, some or all of the functions of the server apparatus 20 may be realized by hardware.

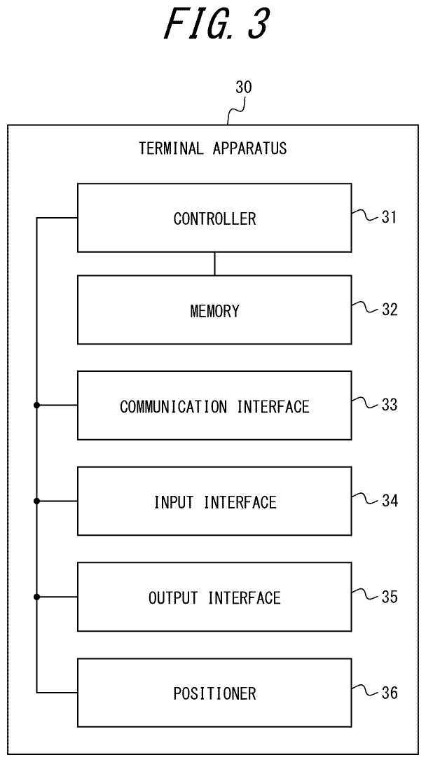

A configuration of the terminal apparatus 30 according to the present embodiment will be described with reference to FIG. 3.

The terminal apparatus 30 includes a controller 31, a memory 32, a communication interface 33, an input interface 34, an output interface 35, and a positioner 36.

The controller 31 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to operations of the terminal apparatus 30 while controlling components of the terminal apparatus 30.

The memory 32 includes at least one semiconductor memory, at least one magnetic memory, at least one optical memory, or any combination thereof. The semiconductor memory is, for example, RAM, ROM, or flash memory. The RAM is, for example, SRAM or DRAM. The ROM is, for example, EEPROM. The flash memory is, for example, SSD. The magnetic memory is, for example, HDD. The memory 32 functions as, for example, a main memory, an auxiliary memory, or a cache memory. The memory 32 stores data to be used for the operations of the terminal apparatus 30 and data obtained by the operations of the terminal apparatus 30.

The communication interface 33 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The communication interface 33 communicates with the server apparatus 20. The communication interface 33 may communicate with the mobile device held by the service staff 11. The communication interface 33 may communicate with the in-vehicle device installed in the service vehicle 12 or the mobile device held by the staff on board the service vehicle 12. The communication interface 33 receives data to be used for the operations of the terminal apparatus 30, and transmits data obtained by the operations of the terminal apparatus 30.

The input interface 34 is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 34 accepts an operation for inputting data to be used for the operations of the terminal apparatus 30. The input interface 34, instead of being included in the terminal apparatus 30, may be connected to the terminal apparatus 30 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 35 is, for example, a display or a speaker. The display is, for example, an LCD or an organic EL display. The term “LCD” is an abbreviation of liquid crystal display. The term “EL” is an abbreviation of electro luminescent. The output interface 35 outputs data obtained by the operations of the terminal apparatus 30. The output interface 35, instead of being included in the terminal apparatus 30, may be connected to the terminal apparatus 30 as an external output device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The positioner 36 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 36 measures the position of the terminal apparatus 30.

The functions of the terminal apparatus 30 are realized by execution of the terminal program according to the present embodiment by a processor serving as the controller 31. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a programmable circuit or a dedicated circuit serving as the controller 31. That is, some or all of the functions of the terminal apparatus 30 may be realized by hardware.

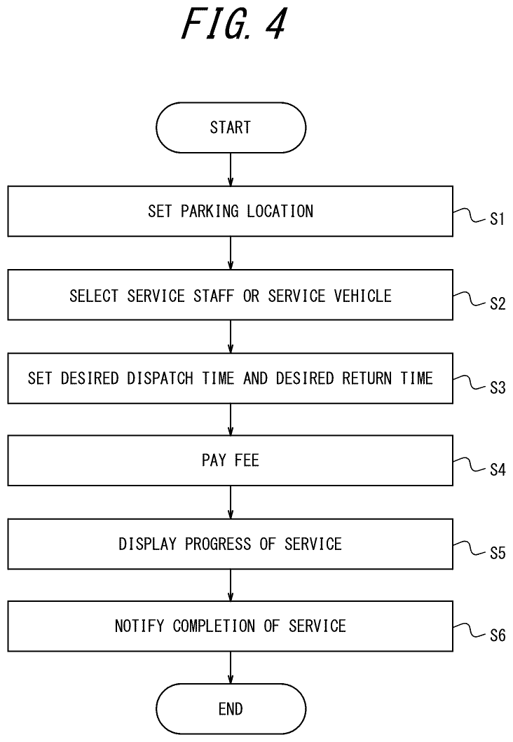

With reference to FIG. 4, operations of the service provision system 10 according to the present embodiment will be described. The operations described below correspond to a service provision method according to the present embodiment. In other words, the service provision method according to the present embodiment includes steps S1 through S6 illustrated in FIG. 4.

When the user U1 starts the terminal program to request the charging service or selects a specific item such as “request service” on a menu screen of the terminal program, step S1 is executed.

In S1, the controller 31 of the terminal apparatus 30 accepts, via the input interface 34, a first user operation to specify a parking location. In the first user operation, not only is the parking location specified, but also information regarding the details of the parking location may be input. The information to be input may include, for example, the name of a building when the parking location is in or adjacent to the building. The information to be input may include information on a parking lot, such as whether the parking lot is on the ground, on the basement, or with a roof, or a parking lot number. The information to be input may include, for example, a photograph of the area around the user vehicle V1 when the user U1 has already parked the user vehicle V1 in the parking location.

In S2, the controller 31 of the terminal apparatus 30 transmits demand data to the server apparatus 20 via the communication interface 33. The demand data is data demanding information that will be helpful in selecting the service staff 11 or the service vehicle 12. Upon receiving the demand data from the terminal apparatus 30 via the communication interface 23, the controller 21 of the server apparatus 20 collects method data via the communication interface 23 from mobile devices held by service staffs 11, in-vehicle devices installed in service vehicles 12, or mobile devices held by staffs on board the service vehicles 12. The method data is data indicating the charging method that can be used by the user U1 for each service staff 11 or service vehicle 12. In the present embodiment, the method data includes data indicating, for each service staff 11, whether the user vehicle V1 is to be moved to a location where a first charging method or a second charging method is supported. The second charging method is a faster charging method than the first charging method. For example, the first charging method is normal charging and the second charging method is fast charging. In the present embodiment, the method data further includes data indicating, for each service vehicle 12, which of the first charging method and the second charging method is supported. The controller 21 of the server apparatus 20 transmits the collected method data to the terminal apparatus 30 via the communication interface 23. Upon receiving the method data from the server apparatus 20 via the communication interface 33, the controller 31 of the terminal apparatus 30 presents the received method data to the user U1 and accepts a second user operation to select a service staff 11 or a service vehicle 12. As the method of presenting the method data, for example, a method of displaying the contents of the method data on a display serving as the output interface 35 of the terminal apparatus 30.

In the present embodiment, upon receiving the demand data from the terminal apparatus 30 via the communication interface 23, the controller 21 of the server apparatus 20 further collects remaining level data from the in-vehicle devices installed in the service vehicles 12 via the communication interface 23. The remaining level data is data indicating the remaining battery level, for each service vehicle 12, that can be used for charging the user vehicle V1. The controller 21 of the server apparatus 20 further transmits the collected remaining level data to the terminal apparatus 30 via the communication interface 23. Upon receiving the remaining level data from the server apparatus 20 via the communication interface 33, the controller 31 of the terminal apparatus 30 presents the received remaining level data together with the method data and accepts the second user operation.

In the present embodiment, upon receiving the demand data from the terminal apparatus 30 via the communication interface 23, the controller 21 of the server apparatus 20 generates recommendation data. The recommendation data is data recommending a facility that can be used by the user U1, the facility differing depending on the charging method indicated by the method data. For example, the recommendation data includes suggestions for possible detours when using the normal charging and possible detours when using the fast charging. As an example, a schedule afterwards according to the charging time is suggested in a way that the normal charging takes 3 hours and enables to go to only a restaurant or tourist spot within a walking distance from the parking location, but the fast charging finishes in 30 minutes and enables to go to a famous restaurant or tourist spot 10 km away from the parking location using the user vehicle V1. Alternatively, if the user U1 is an on-demand bus operator, the recommendation data may indicate the number of people that can be picked up afterwards according to the charging time in a way that how many people can be picked up during the operation time for the normal charging and how many people can be picked up during the operation time for the fast charging. The controller 21 of the server apparatus 20 further transmits the generated recommendation data to the terminal apparatus 30 via the communication interface 23. Upon receiving the recommendation data from the server apparatus 20 via the communication interface 33, the controller 31 of the terminal apparatus 30 further presents the received recommendation data to the user U1 and accepts the second user operation.

In S3, the controller 31 of the terminal apparatus 30 accepts, via the input interface 34, a third user operation to input a desired dispatch time and a desired return time. The desired dispatch time corresponds to the time when the service staff 11 picks up the user vehicle V1, as desired by the user U1 in the case of the agent-type service. The desired dispatch time corresponds to the time when the service vehicle 12 arrives in the vicinity of the user vehicle V1, as desired by the user U1 in the case of the mobile-type service. The desired return time corresponds to the time when the service staff 11 returns the user vehicle V1 after charging, as desired by the user U1 in the case of the agent-type service. The desired return time corresponds to the time when the service vehicle 12 completes charging of the user vehicle V1, as desired by the user U1 in the case of the mobile-type service.

In S4, the controller 31 of the terminal apparatus 30 accepts, via the input interface 34, a fourth user operation to pay for the charging service. In the fourth user operation, a fee may be paid with a fixed payment method or a payment method may be selected. Payment method options include, for example, paying a package rate applied within a specific area, consuming a single use of the number of uses set in subscription, or paying a one-time fec. The controller 31 of the terminal apparatus 30 transmits the request data to the server apparatus 20 via the communication interface 33. The request data is data indicating the parking location that is specified by the first user operation in S1 and the service staff 11 or the service vehicle 12 that is selected by the second user operation in S2 and requesting the charging service. The request data may include the information regarding the details of the parking location, as input by the first user operation. In the present embodiment, the request data includes data indicating the desired dispatch time and the desired return time input by the third user operation in S3. The request data may include data indicating a payment method selected by the fourth user operation. Upon receiving the request data from the terminal apparatus 30 via the communication interface 23, the controller 21 of the server apparatus 20 automatically processes payment for the charging service according to the received request data. Once the automatic process of payment is completed, the controller 21 of the server apparatus 20 performs a process of dispatching the service staff 11 or the service vehicle 12 indicated by the request data to the parking location indicated by the request data. For example, if a worker as the service staff 11 has been selected by the second user operation in S2, the controller 21 of the server apparatus 20 transmits first instruction data via the communication interface 23 to a mobile device held by the selected worker. If a mobile charging vehicle as the service vehicle 12 has been selected by the second user operation in S2, the controller 21 of the server apparatus 20 transmits second instruction data via the communication interface 23 to an in-vehicle device installed in the selected mobile charging vehicle or a mobile device held by a worker on board the selected mobile charging vehicle. The first instruction data is data that instructs the worker to move to the parking location and provide the agent-type charging service. The second instruction data is data that instructs the mobile charging vehicle or the worker on board the mobile charging vehicle to move to the parking location and provide the mobile-type charging service. The first and second instruction data may include the information regarding the details of the parking location. The first and second instruction data may include the data indicating the desired dispatch time and the desired return time.

In S5, the controller 21 of the server apparatus 20 monitors the progress of the charging service. If a worker has been selected by the second user operation in S2, the controller 21 of the server apparatus 20 monitors the progress by communicating via the communication interface 23 with a mobile device held by the selected worker. If a mobile charging vehicle has been selected by the second user operation in S2, the controller 21 of the server apparatus 20 monitors the progress by communicating via the communication interface 23 with an in-vehicle device installed in the selected mobile charging vehicle or a mobile device held by a worker on board the selected mobile charging vehicle. The controller 21 of the server apparatus 20 notifies the terminal apparatus 30 of the progress via the communication interface 23. The controller 31 of the terminal apparatus 30 displays the progress to the display as the output interface 35.

In S6, upon detecting completion of the charging service, the controller 21 of the server apparatus 20 notifies the terminal apparatus 30 of the completion via the communication interface 23. The controller 31 of the terminal apparatus 30 displays a screen indicating that the charging service has been completed, on the display as the output interface 35. In this screen, if a worker has been selected by the second user operation in S2, information regarding the position where the selected worker has stopped the user vehicle V1 may be displayed. A photograph of the user vehicle V1 taken by the selected worker may be displayed.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A non-transitory computer readable medium storing a terminal program for requesting a service to dispatch a service staff or a service vehicle to a location in which a user vehicle is parked and charge a battery installed in the user vehicle, the terminal program being configured to cause a computer to execute operations, the operations comprising:
presenting method data indicating a charging method that can be used by a user for each service staff or service vehicle to the user and accepting a user operation to select a service staff or a service vehicle; and
transmitting request data indicating the service staff or the service vehicle selected by the user operation and requesting the service to a server apparatus.

2. The non-transitory computer readable medium according to claim 1, wherein
the service includes an agent-type service to dispatch a service staff to the location in which the user vehicle is parked, cause the dispatched service staff to move the user vehicle to another location, and charge the battery in a location to which the user vehicle is moved, and
the method data includes data indicating, for each service staff, whether the user vehicle is to be moved to a location where a first charging method or a second charging method that is faster than the first charging method is supported.

3. The non-transitory computer readable medium according to claim 1, wherein
the service includes a mobile-type service to dispatch a service vehicle to the location in which the user vehicle is parked and cause the dispatched service vehicle to charge the battery in the location in which the user vehicle is parked, and
the method data includes data indicating, for each service vehicle, which of a first charging method and a second charging method that is faster than the first charging method is supported.

4. The non-transitory computer readable medium according to claim 1, wherein
the service includes a mobile-type service to dispatch a service vehicle to the location in which the user vehicle is parked and cause the dispatched service vehicle to charge the battery in the location in which the user vehicle is parked, and
the presenting includes presenting remaining level data indicating a remaining battery level for each service vehicle together with the method data.

5. The non-transitory computer readable medium according to claim 1, wherein the presenting includes further presenting to the user recommendation data recommending a facility that can be used by the user, the facility differing depending on the charging method indicated by the method data.
